(19) United States
(12) Patent Application Publication
(10) Pub. No.: US 2005/0141837 A1
(43) Pub. Date: Jun. 30, 2005

(54) Bendable light guide

(75) Inventor: Ming-Shen Sun, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corporation

(21) Appl. No.: 10/747,407

(22) Filed: Dec. 30, 2003

(51) Int. Cl. G02B 6/10

(52) U.S. Cl. 385/129

(57) ABSTRACT

A light guide device having light propagating therein that comprises a first film of a first index of refraction including a surface, a second film of a second index of refraction different from the first index of refraction formed in the first film in a waveform, a plurality of first parts of the second film formed parallel to each other, and a plurality of second parts of the second film corresponding to the first parts formed parallel to each other, wherein a part of the light is reflected toward the surface of the first film when the propagating light is incident upon one of the first parts of the second film.

### DESCRIPTION OF THE INVENTION

1. Field of the Invention

The present invention relates in general to a light guide device and, more particularly, to a flexible light guide device in a liquid crystal display.

2. Background of the Invention

A light guide assembly for a liquid crystal display (“LCD”) typically includes a light source and a wedge-shaped light guide device. The light guide device functions to transform a linear form of light provided by the light source into a planar one. In general, the light guide device in the art is made of acrylic or plastic materials, and does not afford to be bendable because an optical path determined in the structure will be distorted. In addition, it may be difficult to downsize the light guide device due to the nature of the materials.

There is thus a general need in the art for a light guide device and method overcoming at least the aforementioned shortcomings in the art. A particular need exists for a flexible light guide that overcomes optical distortion problems in the art.

### SUMMARY OF THE INVENTION

Accordingly, the present invention is directed to a light guide device and a method of manufacturing the light guide device that obviate one or more of the problems due to limitations and disadvantages of the related art.

To achieve these and other advantages, and in accordance with the purpose of the invention as embodied and broadly described, there is provided a light guide device having light propagating therein that comprises a first film of a first index of refraction including a surface, a second film of a second index of refraction different from the first index of refraction formed in the first film in a waveform, a plurality of first parts of the second film formed parallel to each other, and a plurality of second parts of the second film corresponding to the first parts formed parallel to each other, wherein a part of the light is reflected toward the surface of the first film when the propagating light is incident upon one of the first parts of the second film.

In one aspect, the first parts of the second film form an angle of generally 45 degrees with respect to the surface of the first film.

In another aspect, a part of the light is reflected in a direction normal to the surface of the first film when the propagating light is incident upon one of the first parts of the second film.

Also in accordance with the present invention, there is provided a light guide device having light propagating therein that comprises a pair of first transparent films of a first index of refraction, a base of each of the first transparent films, the base of one first transparent film facing the base of the other first transparent film, a plurality of protrusions of each of the first transparent films being separated from each other on the base of a corresponding first transparent film, the protrusions of one first transparent film being interleaved with the protrusions of the other first transparent film, a space defined between the interleaved protrusions, and a second transparent film of a second index of refraction different from the first index of refraction formed in the space including a plurality of first parts and a plurality of second parts interleaved with the first parts, wherein a part of the light is reflected toward the base of one of the first transparent films when the propagating light is incident upon one of the first parts of the second transparent film.

In one aspect, each of the protrusions further comprises a first side, a second side, and a tapered end connecting the first and second sides.

In another aspect, the first sides of the protrusion are generally perpendicular to the base associated with the protrusions.

Still in accordance with the present invention, there is provided a method of manufacturing a light guide device that comprises preparing a pair of first transparent films of a first index of refraction, providing each of the first transparent films with a base, providing each of the first transparent films with a plurality of protrusions separated from each other on the base of a corresponding first transparent film, each of the protrusions including a tapered end, interleaving the protrusions of one first transparent film with the protrusions of the other first transparent film to define a space between the interleaved protrusions, and filling the defined space with a second transparent film of a second index of refraction different from the first index of refraction.

In one aspect, the method further comprises the step of using an optical glue to serve as the first transparent films and the second transparent film.

In another aspect, the method further comprises the step of engaging the tapered ends of the protrusions of one first transparent film to the base of the other first transparent film.

Yet still in accordance with the present invention, there is provided a method of operating a light guide device that comprises providing a light guide device including a first film of a first index of refraction including a surface, a second film of a second index of refraction different from the first index of refraction formed in the first film in a waveform, a plurality of first parts of the second film formed parallel to each other, and a plurality of second parts of the second film corresponding to the first parts formed parallel to each other, providing a light source that provides light to the light guide device, and reflecting a part of light propagating in the light guide device toward the surface of the first film in a predetermined direction each time when the light is incident upon one of the first parts of the second film.

In one aspect, the method further comprises the step of reflecting the light from the light source at one end of the light guide device and at a different surface of the first film.

In another aspect, the method further comprises the step of converging the light provided by the light source before providing the light to the light guide device.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a schematic diagram of a light guide device in accordance with one embodiment of the present invention;

FIG. 2 is a schematic diagram illustrating a flexible light guide device 10 in accordance with one embodiment of the present invention;

FIGS. 3A, 3B and 3C are schematic diagrams of a light assembly in accordance with one embodiment of the present invention; and

FIGS. 4A and 4B are diagrams illustrating a method of manufacturing a light guide device in accordance with one embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

FIG. 1 is a schematic diagram of a light guide device 10 in accordance with one embodiment of the present invention. Light guide device 10 includes a first film 12 of a first index of refraction and a second film 14 of a second index of refraction different from the first index of refraction. First film 12 and second film 14 include a transparent, optical film. In one embodiment according to the invention, first film 12 and second film 14 include an optical glue. In another embodiment, first film 12 and second film 14 are flexible. First film 12 includes a surface 12-2. Second film 14 is formed in first film 12 in a waveform, and includes a plurality of first parts 14-2 formed parallel to each other and a plurality of second parts 14-4 corresponding to first parts 14-2 also formed in parallel to each other.

In operation, light 16 propagating in light guide device 10 is incident upon a leading first part 14-2 of second film 14. At the boundary between first film 12 and second film 14, a part of light 16 is reflected by the first part 14-2 toward surface 12-2 and another part of light 16 transmits into second film 14. The reflection rate R and the transmission rate T of incident light 16 at the boundary are defined by Fresnel's Law as follows.
R=[(n₁ cos θ₁−n₂ cos θ₂)/(n₁ cos θ₁+n₂ cos θ₂)]²; and
T=1−R
wherein n₁ and n₂ are respectively the first index of refraction of first film 12 and the second index of refraction of second film 14, and θ₁ and θ₂ are respectively the incident angle and refracted angle in accordance with Snell's Law.

First parts 14-2 of second film 14 form an acute angle with respect to surface 12-2 of first film 12. Second parts 14-4 of second film 14 are disposed in such a manner that light 16 departing from first parts 14-2 transmits into second parts 14-4 without refraction. That is, light 16 departing from first parts 14-2 propagates in a direction normal to second parts 14-4. In an embodiment according to the invention, first parts 14-2 of second film 14 form an angle of approximately 45° with respect to surface 12-2 of first film 12. As a result, the part of light 16 reflected by first parts 14-2 transmits in a direction normal to surface 12-2, and second parts 14-4 of second film 14 are disposed substantially perpendicular to surface 12-2 of first film 12.

Due to differences in the refraction index, an offset is generated between an optical path light 16 is incident on one of first parts 14-2 and a different optical path light 16 departs from the one of first parts 14-2. The offset becomes greater as the difference between the first and second indices of refraction becomes greater. To avoid a large offset, the first index of refraction of first film 12 is selected to be close to the second index of refraction of second film 14. In one embodiment according to the invention, the first index of refraction is approximately 1.5.

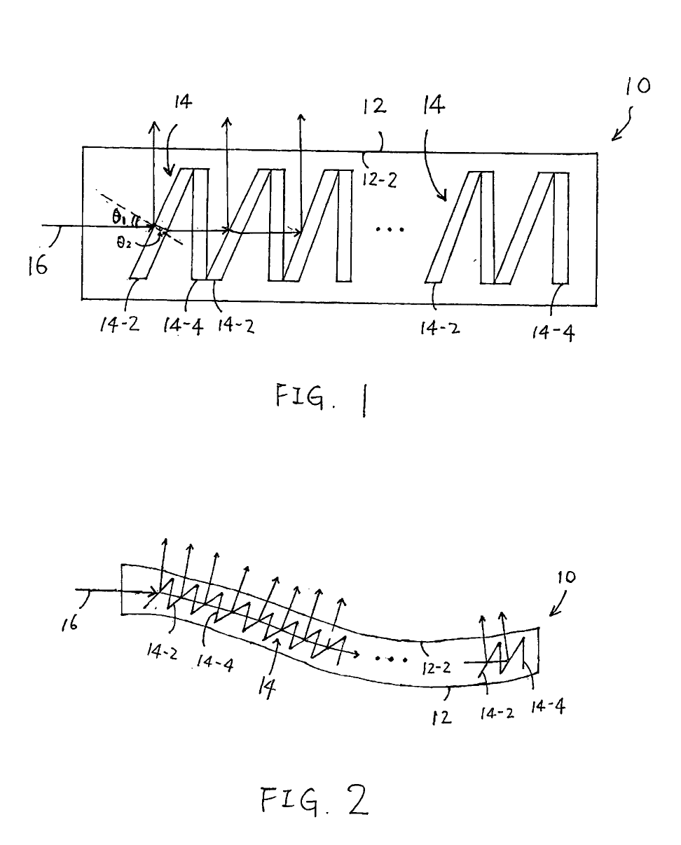

FIG. 2 is a diagram illustrating a flexible light guide device 10 in accordance with one embodiment of the present invention. When first parts 14-2 of second film 14 form an angle of 45° with respect to surface 12-2 of first film 12, light 16 propagating in flexible light guide device 10 is reflected by first parts 14-2 of second film 14 in a direction normal to surface 12-2 of first film 12 over the entire length of flexible light guide device 10.

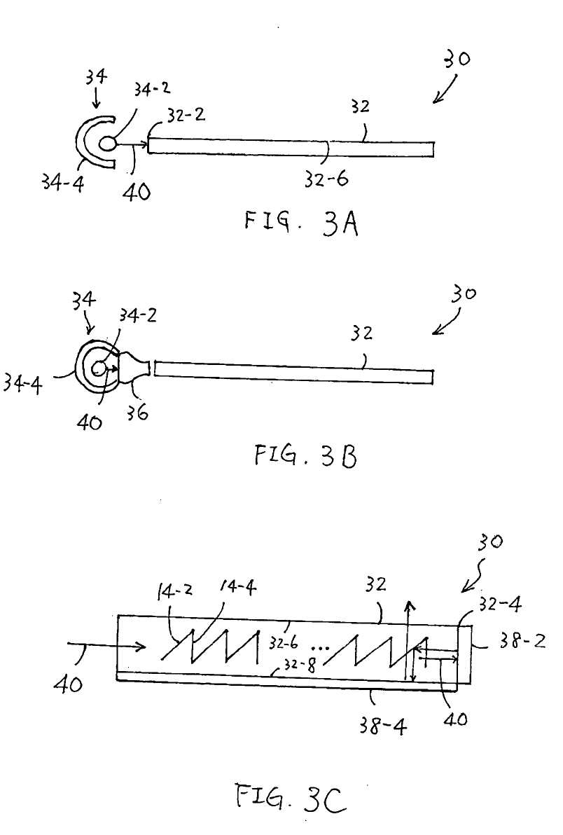

FIGS. 3A, 3B and 3C are schematic diagrams of a light assembly 30 in accordance with one embodiment of the present invention. Referring to FIG. 3A, light assembly 30 includes a light guide device 32 and a light source 34. Light guide device 32 includes a similar structure to light guide device 10 shown in FIG. 1. Light guide device 32 functions to direct light 40 from light source 34 toward a first surface 32-6 of light guide device 32, and transforms a form of linear light provided by light source 34 into a planar one. Light source 34 includes a lamp 34-2 and a reflector 34-4 surrounding lamp 34-2. Light guide device 32 includes an end 32-2 coupled to light source 34.

Referring to FIG. 3B, light assembly 30 may further include a light collector 36 disposed between light guide device 32 and light source 34. Light collector 36 converges the light 40 provided by light source 34.

Referring to FIG. 3C, light assembly 30 may further include a first reflector 38-2 and a second reflector 38-4. First reflector 38-2 is disposed at another end 32-4 of light guide device 32. Second reflector 38-4 is attached to a second surface 32-8 of light guide device 32. First reflector 38-2 and second reflector 38-4 function to reflect light 40 traveling to end 324 toward first surface 32-6 of light guide device 32.

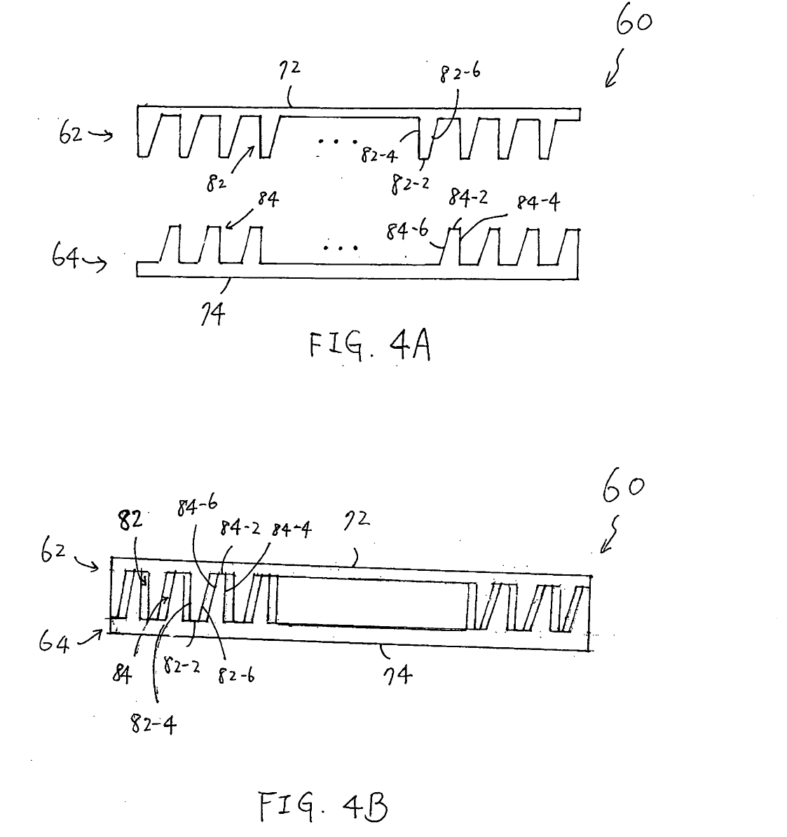

FIGS. 4A and 4B are diagrams illustrating a method of manufacturing a light guide device 60 in accordance with one embodiment of the present invention. Referring to FIG. 4A, a pair of first transparent films 62 and 64 of a first index of refraction is prepared. Each of first transparent films 62 and 64 is then respectively provided with a base 72 and 74, and a plurality of protrusions 82 and 84. Protrusions 82 are separated from each other on base 72. Similarly, protrusions 84 are separated from each other on base 74. Each of protrusions 82 and 84 respectively includes a tapered end 82-2 and 84-2.

Referring to FIG. 4B, protrusions 82 of one first transparent film 62 are interleaved with protrusions 84 of the other first transparent film 64 to define a space (not numbered) between the interleaved protrusions 82 and 84. The interleaving of protrusions 82 and 84 is implemented by engaging tapered ends 82-2 of one first transparent film 62 to base 74 of the other first transparent film 64, and tapered ends 84-2 of the other first transparent film 64 to base 72 of the one first transparent film 62. A second transparent film 66 of a second index of refraction different from the first index of refraction is then filled in the space.

In one embodiment according to the invention, an optical glue is used to serve as first transparent films 62 and 64 and second transparent film 66. The first index of refraction is selected to be close to the second index of refraction. In another embodiment, first and second transparent films 62 and 64 are flexible.

Each of protrusions 82 is respectively further provided with a first side 82-4 and a second side 82-6 connected to first side 82-4 via tapered end 82-2. Similarly, each of protrusions 84 is respectively further provided with a first side 84-4 and a second side 84-6 connected to first side 84-4 via tapered end 84-2. In one embodiment according to the invention, first sides 82-4 of protrusions 82 are formed at approximately a right angle with respect to base 72, and second sides 82-6 of protrusions 82 are formed at an acute angle with respect to base 72. Likewise, first sides 84-4 of protrusions 84 are formed at approximately a right angle with respect to base 74, and second sides 84-6 of protrusions 84 are formed at an acute angle with respect to base 74. In one embodiment according to the invention, second sides 82-6 and 84-6 form an angle of approximately 45° with respect to bases 72 and 74, respectively.

The present invention also provides a method of operating a light guide device 10. Light guide device 10 is provided with a first film 12 of a first index of refraction and a second film 14 of a second index of refraction different from the first index of refraction. First film 12 includes a surface 12-2. Second film 14 is formed in first film 12 in a waveform, and includes a plurality of first parts 14-2 formed parallel to each other and a plurality of second parts 14-4 formed parallel to each other. A light source 34 is then provided to provide light to light guide device 10. A part of light propagating in light guide device 10 is reflected toward surface 12-2 of first film 12 in a predetermined direction each time when the light is incident upon one of first parts 14-2 of second film 14.

In one embodiment according to the invention, the method further comprises the step of reflecting the light provided by a light source toward surface 12-2 of first film 12 at one end of light guide device 10 and at a different surface of first film 12. In another embodiment, the method further comprises the step of converging light provided by a light source before providing the light to light guide device 10.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A light guide device having light propagating therein comprising:
a first film of a first index of refraction including a surface;
a second film of a second index of refraction different from the first index of refraction formed in the first film in a waveform;
a plurality of first parts of the second film formed parallel to each other; and
a plurality of second parts of the second film corresponding to the first parts formed parallel to each other;
wherein a part of the light is reflected toward the surface of the first film when the propagating light is incident upon one of the first parts of the second film.

2. The device of claim 1, the first parts of the second film forming an angle of generally 45 degrees with respect to the surface of the first film.

3. The device of claim 1 wherein a part of the light is reflected in a direction normal to the surface of the first film when the propagating light is incident upon one of the first parts of the second film.

4. The device of claim 1, the second parts of the second film being generally perpendicular to the surface of the first film.

5. The device of claim 1 wherein light departing from one of the first parts of the second film propagating in the first film is in a direction normal to one of the second parts of the second film corresponding to the one of the first parts of the second film.

6. The device of claim 1, the first and second films further comprising an optical glue.

7. The device of claim 1, the first and second films being flexible.

8. The device of claim 1 further comprising an end coupled to a light reflector.

9. The device of claim 1 further comprising an end coupled to a light collector.

10. The device of claim 1, the first film further comprising a different surface to which a light reflector is attached.

11. A light guide device having light propagating therein comprising:
a pair of first transparent films of a first index of refraction;
a base of each of the first transparent films, the base of one first transparent film facing the base of the other first transparent film;
a plurality of protrusions of each of the first transparent films being separated from each other on the base of a corresponding first transparent film, the protrusions of one first transparent film being interleaved with the protrusions of the other first transparent film;
a space defined between the interleaved protrusions; and
a second transparent film of a second index of refraction different from the first index of refraction formed in the space including a plurality of first parts and a plurality of second parts interleaved with the first parts;
wherein a part of the light is reflected toward the base of one of the first transparent films when the propagating light is incident upon one of the first parts of the second transparent film.

12. The device of claim 11, each of the protrusions further comprising a first side, a second side, and a tapered end connecting the first and second sides.

13. The device of claim 12, the first sides of the protrusion being generally perpendicular to the base associated with the protrusions.

14. The device of claim 12, the second sides of the protrusions forming an acute angle with respect to the base associated with the protrusions.

15. The device of claim 12, the second sides of the protrusions forming an angle of generally 45 degrees with respect to the base associated with the protrusions.

16. The device of claim 11 wherein light departing from one of the first parts of the second film propagating in the first films is in a direction normal to one of the second parts of the second film corresponding to the one of the first parts of the second film.

17. The device of claim 11, wherein a part of the light is reflected in a direction normal to the base of one of the first transparent films when the propagating light is incident upon one of the first parts of the second transparent film.

18. The device of claim 11 further comprising an end coupled to a light source via a light collector.

19. The device of claim 11 further comprising a reflector attached to one of the bases.

20. The device of claim 11 wherein the first index of refraction is generally equal to 1.5.

21. A method of manufacturing a light guide device comprising:
preparing a pair of first transparent films of a first index of refraction;
providing each of the first transparent films with a base;
providing each of the first transparent films with a plurality of protrusions separated from each other on the base of a corresponding first transparent film, each of the protrusions including a tapered end;
interleaving the protrusions of one first transparent film with the protrusions of the other first transparent film to define a space between the interleaved protrusions; and
filling the defined space with a second transparent film of a second index of refraction different from the first index of refraction.

22. The method of claim 21 further comprising using an optical glue to serve as the first transparent films and the second transparent film.

23. The method of claim 21 further comprising engaging the tapered ends of the protrusions of one first transparent film to the base of the other first transparent film.

24. The method of claim 21 further comprising providing each of the protrusions with a first side and a second side connected to the first side via the tapered end.

25. The method of claim 24 further comprising forming the first sides of the protrusions at generally a right angle with respect to the base associated with the protrusions.

26. The method of claim 24 further comprising forming the second sides of the protrusions at an acute angle with respect to the base associated with the protrusions.

27. The method of claim 24 further comprising forming the second sides of the protrusions at an angle of generally 45 degrees with respect to the base associated with the protrusions.

28. A method of operating a light guide device comprising:
providing a light guide device including:
a first film of a first index of refraction including a surface;
a second film of a second index of refraction different from the first index of refraction formed in the first film in a waveform;
a plurality of first parts of the second film formed parallel to each other; and
a plurality of second parts of the second film corresponding to the first parts formed parallel to each other;
providing a light source that provides light to the light guide device; and
reflecting a part of light propagating in the light guide device toward the surface of the first film in a predetermined direction each time when the light is incident upon one of the first parts of the second film.

29. The method of claim 28 further comprising reflecting the light from the light source at one end of the light guide device and at a different surface of the first film.

30. The method of claim 28 further comprising converging the light provided by the light source before providing the light to the light guide device.
